(19) United States
(12) Patent Application Publication
(10) Pub. No.: US 2003/0154117 A1
(43) Pub. Date: Aug. 14, 2003

(54) Method and system for job-placement of disabled workers

(76) Inventor: Mary Joan Willard, Mill Valley, CA (US)

Correspondence Address: Risto A. Rinne, Jr., Suite E, 2173 East Francisco Blvd., San Rafael, CA, 94901, US

(21) Appl. No.: 10/074,507

(22) Filed: Feb. 12, 2002

(51) Int. Cl. G06F 17/60

(52) U.S. Cl. 705/8

(57) ABSTRACT

A method and system useful in creating long-term job opportunities for disabled and blind individuals who wish to work on a government contract that will be, or has been, awarded to a private sector company includes providing a not for profit staffing service with a work force performing direct labor that includes at least seventy-five percent disabled or blind individuals. The not for profit staffing service is informed either directly or through the NIB or NISH agencies of various types of potential job opportunities for the future or of actual, current job opportunities involving work to be performed under the government contract. The not for profit staffing service then informs disabled and blind individuals of the potential or of the actual job opportunities and accepts their applications. Once the contract has been awarded, the not for profit staffing service refers, or assists in the referral of, at least some of the disabled applicants to an appropriate contact person of the private-sector company that has been awarded the contract. The applicants that are to be hired are hired as employees of the not for profit staffing service who perform work at or for the private-sector company.

### BACKGROUND OF THE INVENTION

1. Field of the Invention

The present invention, in general relates to the hiring of disabled workers and, more particularly, to a method and system for nationally recruiting severely disabled and blind workers by a nonprofit organization for whom they shall work, and of placing the workers in long-term positions (i.e., at least one year in duration) at the location of a prime contractor who is awarded a government contract.

Accordingly, the nonprofit organization remains in conformity with either state or federal procurement preferential hiring programs.

Initially since 1938 and then amended in 1978 federal legislation has been in place that gives hiring preference to non-profit agencies whose work force consists of at least 75% of individuals with severe disabilities, including those affected by blindness. This legislation is collectively known as Javits-Wagner-O'Day or hereinafter as “JWOD”.

The intention behind JWOD legislation is to help disabled people by providing a hiring preference that increases the employment opportunities for those individuals who are severely disabled or blind.

Two federal agencies have been formed to oversee the implementation of such legislation, namely the National Industries for the Blind, hereinafter as “NIB” and the National Industries for the Severely Handicapped, hereinafter as “NISH”.

JWOD designates a federal agency consisting of approximately thirty people to oversee the implementation of the JWOD legislation. That federal agency is known as “The Committee for Purchase of Services from Blind and Severely Disabled”.

The Committee for Purchase of Services from Blind and Severely Disabled has, in turn, designated two not for profit organizations, namely NIB and NISH, to implement JWOD.

Whenever the term “disabled” is used herein it includes either disabled, severely disabled, or blind individuals whose impediments are sufficient to meet the requirements of JWOD federal legislation or similar types of state legislation.

Approximately 36,000 individuals with severe disabilities are currently employed by approximately 500 non-profit organizations that are working on JWOD federal contracts. Typically, ten or more severely disabled people work for any of these non-profit organizations on any given contract. These are long-term (i.e., having an expected term of employment that is one year or greater in duration) positions.

Another 90,000 or so individuals with severe disabilities are working in approximately 30 states that have adopted state-based preferential hiring programs similar to that of JWOD. These individuals are performing contract work for the various state governments. This work has been similarly outsourced to non-profit organizations that employ disabled people in the respective states.

At first glance, it would appear that JWOD is working, first on the federal level to which it applies and again when its principles are mimicked on the state level, but there are two or three significant problems that the implementation of this legislation has created. The first such problem concerns the type of work that is being performed by the vast majority of these severely disabled people and the second and third problems appertain to the actual work environment.

Generally, in the community providing support to disabled individuals the resultant types of jobs that JWOD type contracts provide to severely disabled people are sometimes referred to as appertaining primarily to “food and filth”, which means that they appertain to either low-skilled food preparation types of jobs or to janitorial and custodial services, hence the broad compass of “food and filth”.

There is ample reason why this is so. The non-profit organizations which seek to obtain a disabled worker hiring preference have been required to employ individuals with severe disabilities that comprise a minimum of 75% of their work force. It not practical for such nonprofit types of organizations to seek out and to include a great variety of specialized skills amongst the disabled population and then effectively market themselves as either prime contractors vying directly for these government contracts, or for that matter, to market themselves as sub-contractors vying to work on a government contract while reporting to a prime contractor.

It is not feasible for these types of nonprofit organizations to hire a proper mix of engineers, computer programmers, systems analysts, structural analysts, and other specialized disabled workers who would comprise at least 75% of their work force and be able to keep them continuously employed long term. If the non-profit can not be assured of keeping their disabled work force employed, then they can not be certain of maintaining at least 75% of their work force as disabled. Failure to do so could preclude their participation in JWOD related programs.

The long-term staffing of disabled workers has primarily been for low skilled positions only. What is known is the temporary staffing of federal jobs at federal facilities and only then for short term positions (i.e., 120 day contracts with a maximum extension of an additional 120 days through a Basic Ordering Agreement [hereinafter “BOA”] that is administered under the General Services Administration [hereinafter “GSA”]).

This type of a service is used when a federally employed secretary, for example, goes on a 90 day leave to have a baby and a temporary but disabled worker is hired to fill the position and to work at the federal facility while the secretary is on leave. There is no known way to recruit disabled workers for long term positions that include working with (i.e., at the site) of private sector companies and where various skill levels and varying types of job descriptions are involved.

And even if the nonprofit were to hire a mix of skilled disabled workers, the nonprofit organization would be unable to market themselves because the extent of services that they could provide would not neatly fit into any function or service category. In other words, there would not be a contract that had a perfect match with the disabled talent work force that they had recruited. Therefore, some of these workers could not be employed on a full-time basis. The 1)J problem that possibly less than 75% of the work force would be disabled, as mentioned hereinabove, then arises.

If one were to think that the nonprofit organization could somehow adapt and market itself as a source of skilled disabled workers, this assumption too would be false because there is no telling where, geographically, a government contract will be awarded. Will the long-term government procurement contract be awarded to a firm in Seattle, Tex., or New England? Are skilled disabled workers generally willing to uproot move and work in a distant area? The answer is no.

Therefore, these non-profit organizations have focused on low-skilled types of work, in particular, janitorial, custodial, grounds maintenance, laundry, mailroom, administrative assistance (i.e., secretarial), food service, simple manufacturing, and assembly positions.

Consequently JWOD, despite the best of intentions, has not been optimally effective at providing job opportunities for highly skilled and specialized ability individuals with disabilities.

The remaining second problem created by the implementation of JWOD is that it has resulted in the clustering of disabled workers together into what are groups of disabled individuals. This is potentially psychologically damaging for it furthers the stigma associated with being a disabled person by means of segregation. Segregation furthers a belief in difference. It implies that disabled people are somehow different enough so that perhaps they require a sort of quarantining and placement away from the mainstream work force.

An ideal implementation of the intent of JWOD would mainstream disabled workers in an integrated work force, working amongst both disabled and non-disabled employees. This has not occurred to any significant degree thus far.

An integrated type of work environment would help the disabled worker to feel better about himself or herself. It would also benefit society as a whole for it would help to raise individual consciousness about the abilities of severely disabled individuals to contribute in highly skilled jobs and at high functioning levels, while lessening patterns of discrimination, whether intentional or inadvertent. It is ultimately a negative attitude that serves to limit job opportunities and potential for severely disabled workers.

The current prevailing attitude is unfortunately that disabled individuals are substantially best suited for “food and filth” types of jobs. This is because the vast majority of the 500 non-profit organizations that employ disabled individuals are businesses that perform a function for the government (i.e., any of those mentioned hereinabove).

It is similarly believed that prime contractors who function as non-profits cannot possibly offer highly skilled yet severely disabled workers to fill JWOD job requirements. For the majority of contracts under JWOD, the non-profit functions as the prime contractor (to perform a given function such as food preparation, janitorial, or ground maintenance) for federal projects at federal buildings and facilities. Accordingly, skilled and highly skilled disabled workers are often overlooked.

The third problem involving the implementation of JWOD also concerns the environment where the disabled workers actually work (as mentioned above, usually in clusters of disabled workers) and at federal facilities.

The federal government has mandated the various federal agencies to give hiring preference to disabled individuals. Clearly, they have authority to do so and this has resulted in additional direct hiring of disabled individuals by the federal government. Once again, there is stigma in that the federal government appears to be the only show in town that will hire disabled individuals, thereby suggesting that they somehow cannot make it in the private sector.

When the federal government awards a procurement type of a contract, it is to a company in the private sector, meaning it is not an agency of the federal government. While the federal government can greatly influence the hiring of disabled workers by federal agencies, attempting to persuade private sector companies to do so is not easy to accomplish.

One strategy is for the federal government to require, as part of the terms of the contract itself, to hire a minimum number of disabled workers. This would mean that the private sector prime contractor will have to hire some additional disabled workers, all of whom (under JWOD) would remain as employees of a non-profit organization. For the reasons mentioned earlier, this means that they will most likely be in “food and filth” related services.

In those instances where an awarded contract is large and encompasses a need for workers other than the typical “food and filth” arena that the nonprofit specializes in, the nonprofit would then serve as a mandatory subcontractor that reports to the prime contractor who wins the government procurement contract.

Therefore, the federal government is able to indirectly influence private sector companies who become the prime contractor to hire some additional disabled workers.

This is advantageous to the government and to the public, in general. It has been stated by a JWOD spokesperson that in a review of a large government procurement contract that resulted in the hiring of 205 people with disabilities, the year prior to their employment these people received over nine-hundred thousand dollars of taxpayer assistance. The year after their hiring showed that they paid about one million dollars in taxes. The net effect to the federal government was a gain in funding of approximately 1.9 million dollars. Clearly, it is in everyone's interest to hire as many disabled individuals as is possible.

An example would be if Boeing Aircraft Corporation is awarded a large contract to build airplanes in Seattle for the Air Force, and if approximately 1000 workers over the course of five years are required to satisfy the contract, then a small percentage of “food and filth” low-skilled service types of jobs could be filled by severely disabled workers. The government contract may, in fact, mandate that a small percentage of the workers for such large contracts be disabled.

As each non-profit that serves NIB and NISH hire unskilled workers, maybe only one-half of one percent of the jobs are suitable low-skilled jobs that the non-profits can presently fill. Therefore, the prime contractor (Boeing in this instance) may be required (perhaps as mandatory language in the government procurement contract) to use one-have of one percent of disable (JWOD) workers (whom are recruited and employed by the non-profit organizations that are affiliated with NISH or NIB agencies and which are located in Seattle, for example).

These disabled workers must remain as employees of the non-profit agency and they must remain on the non-profit's payroll long term (i.e., over one year) while performing their duties (usually) at the site of prime contractor. The non-profit then becomes a subcontractor that reports to the prime contractor (Boeing). Once again, these are low-skilled workers.

Consequently, severely disabled and blind individuals are provided with relatively few job opportunities (i.e., five to ten positions in the above example) and they tend to be very low-skilled in nature.

For some contracts, even though JWOD legislation compels federal contract officers to contact NIB or NISH before putting out a contract for general bid, they often assume that there is no way NIB or NISH can, using the non-profits at their disposal, satisfy the highly specialized types of jobs that a particular contract may require.

In the preceding example, a federal contract officer charged with complying with the legislation is markedly unlikely to even consider first soliciting NIB or NISH to see if there is a non-profit organization “out there” that can supply severely disabled or blind engineers from a given branch of science, computer programmers, accountants, or systems analysts. The federal contract officer knows that this is not possible.

To continue the preceding example of building airplanes for the Air Force, the federal contract officer would not contact NIB or NISH looking for engineers, etc., to help build the airplanes, but would instead put the contracts out directly to suitable private sector companies, like Boeing. Without meaning to do so, higher skilled long-term positions for disabled individuals are overlooked by the process as it now functions.

Consequently, highly skilled blind and severely disabled individuals are largely excluded from JWOD-based hiring opportunities.

Most skilled types of jobs will also require that the individual be present at the actual job site. As mentioned hereinbefore, it is also desirable to mainstream disabled workers whenever possible. The problem of locating skilled and highly skilled blind and severely disabled individuals that can work long-term in a particular geographic area has not been effectively addressed hereinbefore.

Some other types of support positions (for larger icontracts) may lend themselves to telecomuting opportunities for disabled and blind individuals. In all cases there are many positions that blind or disabled individuals could fill if only a way existed that would permit a nonprofit to locate such workers, ascertain what their skill levels are and where geographically they are able to work, and then present these workers to the prime contract holder.

Ideally each prime contract bidder or ultimate holder (i.e., winner that is awarded the contract) would contact NIB and NISH for a referral to a nonprofit that could provide long-term skilled (and some unskilled) disabled workers and do so for any given geographical area. The disabled individuals would remain as employees of the nonprofit. The employees of the nonprofit would then, in essence, subcontract their services by working at the site of the prime contract holder.

If such a method and system existed, it could foster the creation or amending of legislation so as to mandate the hiring of a reasonable percentage of disabled or blind workers to fill a variety of positions for any given government procurement contract that is awarded to a private sector company by requiring the federal procurement contract officer to write in the contract that winning bidder who becomes the prime must fill a percentage of skilled types of jobs as well as low-skilled positions with disabled workers.

Ideally, this effort would best begin by having each and every bidder for any given government procurement contract start by contacting NISH, for example, and providing a listing of the range of skills that they believe are going to be required (i.e., anticipated job descriptions) to fill the contract, the duration that those skills will be needed for, and where the work is to be performed, and possibly other information as well.

Without substantially increasing the burden to NISH, because NISH would then only make a referral of these potential job requests to a particular non-profit, the non-profit organization would then post descriptions of the types of jobs needed by all of the bidders (if they were to win the bid) in a variety of ways to acquire applications from disabled workers capable of filling a variety of these positions and then offer these applicant workers to the prime contractor (i.e., the winning bidder) for hiring consideration.

The prime contractor, if mandated to hire a given percentage of disabled workers, would then interview the disabled applicant workers whom were referred by the nonprofit, selecting those it felt were suited yet these workers would remain as employees of the nonprofit (i.e., the subcontractor) thereby complying with JWOD legislation.

Of course, some of these positions could well include low skilled positions, however an opportunity to fill jobs across the skill-level spectrum with disabled workers would be optimally achieved.

The locating of skilled disabled workers and of offering them to prime contractors for long-term employment at private sector companies has not been accomplished hereinbefore.

Accordingly, there exists today a need for a method and system for job-placement of disabled workers in positions that include skilled and highly skilled positions for contracts that are at least one year in duration and which includes working with a private sector company.

Clearly, such a method and system would be useful and desirable in promoting job opportunities for disabled and blind individuals.

2. Description of Prior Art

Various means of locating disabled workers to fill temporary services such as those administered by BOA are, in general, known. As mentioned hereinabove, the known prior art methods are intended to satisfy the short term staffing requirements at federal facilities. No method and system to permit the long-term recruitment of disabled and blind individuals with a range in abilities from low-skilled to highly-skilled that are adapted to fill a variety of positions working for a nonprofit organization that is a subcontractor to a prime contractor when the prime contractor is a private-sector company, is presently known.

While the structural arrangements of the above described systems and methods, at first appearance, may have some similarities with the present invention, they differ in material respects. These differences, which will be described in more detail hereinafter, are essential for the effective use of the invention and which admit of the advantages that are not available with the prior devices.

### OBJECTS AND SUMMARY OF THE INVENTION

It is an object of the present invention to provide a method and system for job-placement of disabled workers that complies with existing JWOD requirements.

It is another object of the present invention to provide a method and system for job-placement of disabled workers that is adapted to comply with likely changes in JWOD requirements.

It is also an important object of the invention to provide a method and system for job-placement of disabled workers that includes a national non-profit staffing service.

Another object of the invention is to provide a method and system for job-placement of disabled workers that includes skilled and highly skilled disabled and blind workers that are suited to fill any given position.

Still another object of the invention is to provide a method and system for job-placement of disabled workers that includes disabled and blind individuals who possess a variety of job skills.

Still yet another object of the invention is to provide a method and system for job-placement of disabled workers at various locations across the country.

Yet another important object of the invention is to provide a method and system for job-placement of disabled workers in compliance with federal JWOD legislation.

Still yet another important object of the invention is to provide a method and system for job-placement of disabled workers in long term job placements.

A first continuing object of the invention is to provide a method and system for job-placement of disabled workers that provides for the integration of disabled workers with non-disabled workers at the job site of a private sector company.

A second continuing object of the invention is to provide a method and system for job-placement of disabled workers that is adapted to locate disabled individuals with target skills that can work at locations specified by a prime contractor.

A third continuing object of the invention is to provide a method and system for job-placement of disabled workers that is adapted to locate disabled individuals with target skills that can work at a location specified by any of a plurality of bidders, each bidder seeking to become the prime contractor for a particular government contract.

A fourth continuing object of the invention is to provide a method and system for job-placement of disabled workers that is adapted to locate disabled individuals with target skills before the prime contractor is known (i.e., before the contract has been awarded to one of the bidders) and be ready (i.e., poised) to fill a variety of long-term skilled and highly skilled positions, including technical positions, at the location of the prime contractor with disabled individuals once the contract is awarded.

A fifth continuing object of the invention is to provide a method and system for job-placement of disabled workers that is adapted to place disabled individuals in positions working at private sector companies (not working at federal agencies).

A sixth continuing object of the invention is to provide a method and system for job-placement of disabled workers that is adapted to locate disabled individuals with target skills after the prime contractor is known (i.e., after the contract has been awarded to one of the bidders) and be ready (i.e., poised) to fill a variety of long-term skilled and highly skilled positions, including technical positions, at the location of the prime contractor with disabled individuals once the contract is awarded.

Briefly, a method and system for job-placement of disabled workers that is in accordance with the principles of the present invention has a database that includes files appertaining to a pending government contract. The files are provided by each bidder and they include the location or locations where work is to be performed, the duration of the contract, and a description of the various types of positions that are required to be filled. The database is preferably maintained by a nonprofit organization (i.e., a subcontractor) that employs at least 75% severely disabled or blind workers. All contractors that are bidding to win a government contract or which have been awarded a government contract timely supply the nonprofit organization (either directly or through NIB or NISH) with location, duration, job-type information, pay range information, and any other pertinent information that is deemed to be relevant to the contract. This information is used to create certain of the files in the database. The nonprofit organization then posts potential job opportunities including the job's location, duration, and any other information that is deemed to be relevant, such as the pay range for any position. The posting can occur in a variety of ways, such as on the Internet, by mass media, telephone contact, through NIB and NISH (or their affiliated agencies), or any other suitable method. Severely disabled or blind workers who feel they meet the requirements are invited to apply to the nonprofit, specifying the required information, such as their skill level and experience history, geographic availability, time availability, salary range, or any other relevant information. The nonprofit compiles potential applicant worker files for each possible contractor. The potential applicant worker files include applicant resumes of those workers who may be potentially suitable for any of the positions by any of the potential prime contractors that are bidding for the government contract. After the contract has been awarded to one of the bidders who then becomes the prime contractor, the potential worker files that contain potentially suitable disabled workers in the appropriate geographical area are used and contact is made with those potential workers who are then referred to recruitment personal of the prime contractor where they go through a screening and hiring process that is administered by the prime contractor (as part of the prime contractor's mandatory requirement to hire at least a minimum percentage of disabled workers) who are to be utilized, ideally, for the duration of the contract. The prime contractor informs the nonprofit which of the disabled workers it wants to hire. These workers then remain on the payroll of the nonprofit, not as employees of the prime contractor, thereby achieving full compliance with JWOD requirements. These disabled workers typically report each day to the job site of the private sector prime contractor where they mingle amongst the non-disabled workers who have also been hired by the prime contractor. The difference is that the non-disabled workers may be hired as direct employees of the prime contractor. The prime contractor's winning bid must include salary compensation for the disabled workers and for the overhead and services that are provided by the nonprofit organization or agency. Accordingly, the prime contractor pays the nonprofit an amount that exceeds the salary of each hired disabled worker. The excess is used to fund operation of the nonprofit organization. Therefore, disabled and blind individuals are afforded unprecedented job placement opportunities for all government procurement contracts that are awarded to private sector companies and which are to be performed anywhere in the nation and, accordingly, for any particular type of job requiring skilled and/or highly skilled positions, disabled individuals are given hiring preference, in optimal conformity with the intent of existing JWOD legislation. In addition, disabled workers are optimally “mainstreamed” into the general private sector work force where they appear to be employees of the prime contractor while, in fact, they remain as employees of the nonprofit organization. The method and system can also be utilized after a government contract has been awarded and either the prime contractor or a sub-contractor to the prime contractor needs or desires to employ disabled individuals. The prime contractor or the sub-contractor can then contact either NIB or NISH (which in turn contacts the nonprofit organization) or the prime contractor or the sub-contractor can contact the nonprofit organization directly supplying the necessary job information. The nonprofit organization then uses its resources to solicit disabled individuals who are hired as employees of the nonprofit organization to work at either the prime contractor or the sub-contractor's site.

### BRIEF DESCRIPTION OF THE DRAWINGS

FIG. 1 is a block diagram of a method and system for job-placement of disabled workers.

FIG. 2 is a flowchart of the steps of posting job positions, obtaining job applicants, and referring job applicants.

### DETAILED DESCRIPTION OF THE INVENTION

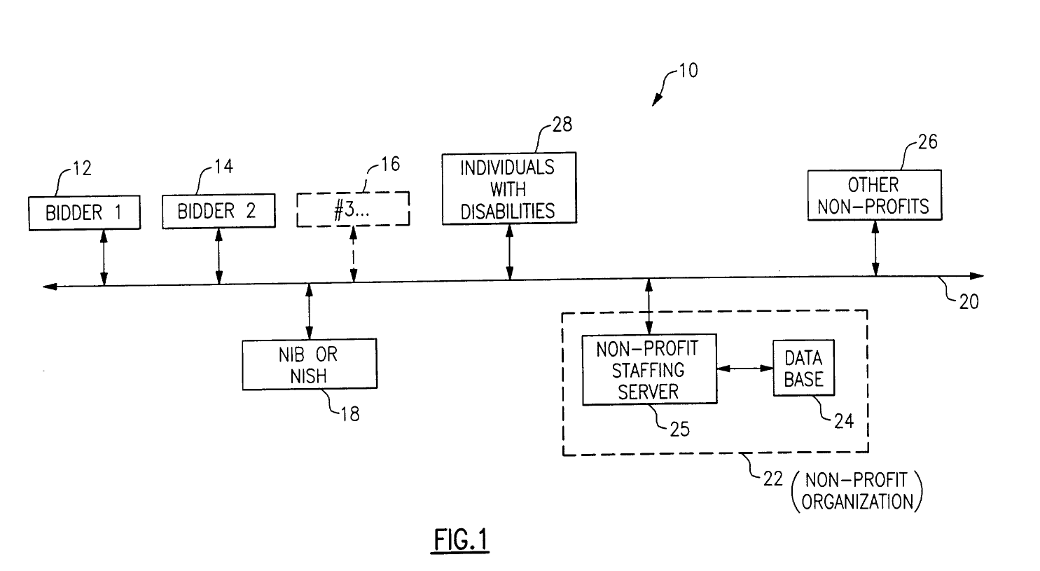

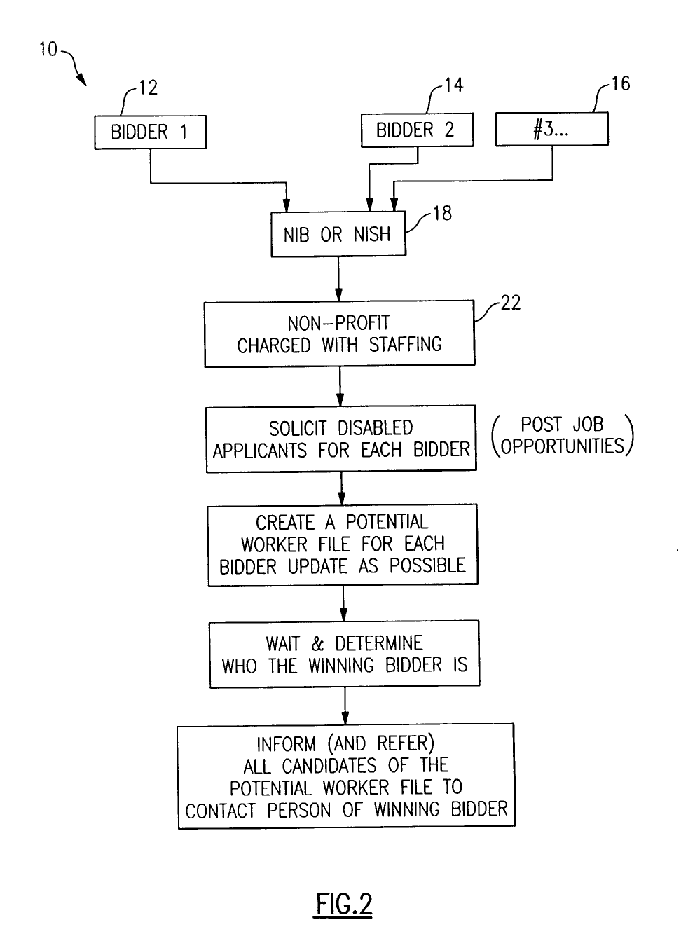

Referring to FIG. 1 and on occasion to FIG. 2 is shown, a method and system for job-placement of disabled workers, identified in general by the reference numeral 10.

A first bidder 12 and a second bidder 14 and other additional bidders 16 are competing for a government procurement contract that has a duration of at least one year. It is important to note the method and system for job-placement of disabled workers 10 applies to long-term positions for disabled workers, thereby differentiating the purpose apart from any temporary or short-term staffing service.

Initially, it is not known which of the bidders 12, 14, 16 will be awarded the contract. It is assumed that each of the bidders 12, 14, 16 is located in a separate geographical area, perhaps in distally located states that are dispersed across the nation.

According to the method and system for job-placement of disabled workers 10, the bidders 12, 14, 16 will each supply a job requirements file (i.e., a list) of the various jobs, both skilled and unskilled, that need to be filled in order to complete the contract.

It is possible to modify certain aspects of the method and system 10. For example, alternatively, a generic job requirements file could be supplied by some federal agency involved in the procurement process, knowing to some degree the types of jobs that will be required.

The job requirements files that are supplied by each bidder 12, 14, 16 (preferred) will likely have much in common due to the common nature of the work that is required, but there will be variations in the jobs that are required due to variations in the “in-house” resources that are available to each of the bidders 12, 14, 16. Also, the bidders 12, 14, 16 may be located in different parts of the country. Each bidder 12, 14, 16 separately compiles and supplies their own job requirements file. This file represents the additional employees that each bidder 12, 14, 16 anticipates having to hire if they are awarded the contract.

The job requirements files of each bidder 12, 14, 16 are preferably sent to some oversight agency, in this case either to NIB or NISH 18. Preferably, communication takes place over the Internet 20, although other forms of communication including postal mail are certainly possible.

The Internet 20 is preferred because all parties involved, as is described in greater detail hereinafter, may be easily and quickly communicated with at various times during the implementation of the method and system 10.

NIB or NISH 18 then transfers the jobs files to a non-profit organization 22 (which functions as a not for profit staffing service) that is charged with providing long-term disabled (and blind) staffing options to the bidder 12, 14, 16 who is finally awarded the contract. Let us assume that the second bidder 14 will eventually wins (i.e., is awarded) the contract and therefore becomes the prime contractor thereof. Let us assume that this does not happen until later as we first consider further the operation and implementation of the method and system for job-placement of disabled workers 10.

The non-profit 22 uses the job requirements files it has received to determine what types of jobs will be required by each of the bidders 12, 14, 16 (not knowing at this time which one will be awarded the contract), how many of each will be required, the location where work is to be performed, the anticipated start and finish times for the contract and for each posted position within the contract, the salary range for each position and any other relevant information.

The non-profit 22 stores the job requirements files, with any edits, additions, or omission that it feels are needed, in its own database 24, using its server 25. The server 25 is operatively connected to the Internet 20.

If desired, the bidders 12, 14, 16 could, of course, supply the jobs files directly to the non-profit 22 in addition to, or in lieu of, sending them to NIB or NISH 18. This is but one of many variations that can be made to optimize performance of the method and system for job-placement of disabled workers 10 in accordance with the desires of the participants thereof without departing from the spirit or scope of the invention.

The non-profit 22 organization must employ at least 75% of its work force as either disabled, severely disabled, or blind in order to comply with JWOD requirements as they relate to the method and system for job-placement of disabled workers 10. As will be described hereinafter in greater detail, the disabled workers that are ultimately hired remain as employees of the non-profit 22, thereby making this requirement easy to satisfy.

The non-profit 22 therefore knows the entire gamut of potential jobs that will be needed for each prospective bidder 12, 14, 16. Not knowing which bidder 12, 14, 16 will be awarded the contract, it creates, stores in the database 24, and posts separate potential job positions in any of a variety of ways and at any of a variety of locations deemed necessary.

For example, the non-profit 22 may post the jobs of the second bidder 14 that happens to be located in Seattle, Wash. with other non-profit organizations 26 that serve the disabled and blind communities and which are also located in or near Seattle. The various other non-profit organizations 26 are a good source of potential disabled workers who may, in turn, elect to provide copies of their resumes to the other non-profits 26 that are located close to where they live. Accordingly, an unexpected benefit provided by the method and system 10 is that all of the agencies involved with helping the blind or disabled population can cooperate with each other to better serve their clientele.

The non-profit 22 organization that is charged with the national disabled staffing assistance for this government contract would not necessarily post the jobs file of the first bidder 12 at the other non-profit 26 if it deemed the other non-profit 26 was geographically too far removed from the job site of the first bidder 12. Alternately, the non-profit 22 would likely post the jobs file of the first bidder 12 at yet further non-profit organizations (not shown) that are located nearer the location of the first bidder 12. These postings rely upon using the Internet 20 jog and other sources as well.

The non-profit 22 may also post the various job opportunities by emailing directly various individuals with disabilities 28, of whom it maintains files or resumes in the database 24. Alternately, the non-profit 22 could notify the various individuals by communicating by mail or by telephone.

The non-profit 22 may also notify NIB or NISH 18 (or both) of the various job opportunities and they may use NIB or NISH's vast resources to help disseminate information concerning the availability of these potential job opportunities to the disabled and blind communities.

Regardless of how these potential job opportunities are posted and how the disabled individuals are made aware of them, they are invited to apply to the non-profit 22 for any prospective position as posted (by each of the bidders 12, 14, 16) that they feel qualified to work at providing they are willing to work in the appropriate geographic area of the bidder 12, 14, 16 and providing that they are willing to work for the time duration that is required by the contract.

The non-profit 22 compiles these job applications or resumes that it receives to create a potential worker file of job applicants for each separate bidder 12, 14, 16. The potential worker files are maintained and are updated (when new disabled or blind applicants apply) in the database 24.

Some of the individuals with disabilities 28 may appear on more than one potential worker file, that is to say a particular disabled electrical engineer (not shown) that lives near the location of the first bidder 12, but is also willing to move to Seattle if need be, may apply for both positions and would likely be included in the potential worker file for the first bidder 12 and also in the potential worker file for the second bidder 14. If that individual was unwilling to work at the location of the third bidder 16, he or she would not be included in their respective potential worker file.

The individuals with disabilities who apply for these positions are informed from the onset that none of these prospective positions are going to be required with certainty. They are tentative positions, the very existence of depends upon which bidder 12, 14, 16 is finally awarded the government contract. Those whom apply are made so aware and they apply for a chance at working in their area of expertise at the location of a private-sector company that has applied to be the prime contractor of the contract.

The non-profit 22 must then wait until the contract is actually awarded to one of the bidders 12, 14, 16. According to the example described earlier, that is assumed to be to the second bidder 14.

Upon being awarded the prime government contract, the second bidder 14 becomes the prime contractor and the non-profit 22 becomes, in essence, a subcontractor to the prime contractor (i.e., the second bidder 14) by helping the second bidder 14 satisfy its staffing requirements. All of the staffing requirements which the non-profit 22 can satisfy are of course those workers who are either disabled or blind. These workers appear on the potential worker file of applicants for the second bidder 14.

At this time the non-profit 22 uses the potential worker file for the winning second bidder 14 as a source of candidate disabled workers. Each of these disabled workers is then referred to the prime contractor (i.e., to the second bidder 14) for interviews and for possible hiring. The prime contractor maintains control over whom works on their government contract, including the disabled workers.

Referral can be accomplished in any of several ways.

The applicant workers appearing on the potential worker file of the second bidder 14 can, for example, be contacted directly by the non-profit 22 (such as by mail or email over the Internet 20 or by telephone). They would then be referred to an initial contact human-resources person working for the winning second bidder 14, whom they (the applicants) would call or otherwise contact. For example, the non-profit 22 could simply tell each disabled applicant whom to call as the contact person for the prime contractor and leave it up to each applicant to place the call.

Alternatively, the non-profit 22 could make the referrals in any of several other ways as described hereinafter and possibly in other ways not specifically described herein.

In any event, the contact person or his designee would cooperate with the applicants to set up interviews with those disabled workers that are felt to be a potential match with the needs of the prime contractor. That could include all of those who applied or only a select group of those that applied for positions.

There might, of course, be several different contact human resources people whom the applicant disabled workers would then contact, depending upon the size of the contract that was awarded or the size of the company of the winning second bidder 14. Each particular contact person may be assigned to handle a particular range of skill (i.e., job descriptions), for example.

Alternatively, the non-profit 22 can screen and send select resumes of the disabled workers that appear on the potential worker file (of the second bidder 14) to the prime contractor for consideration. The prime contractor is then able to contact, either directly or through the non-profit 22 or possibly even through some other support agency, those disabled individuals that it is interested in interviewing and possibly, in hiring.

Alternatively, the non-profit 22 can transmit or otherwise deliver a file (such as by email over the Internet 20) to the prime contractor of any or all of the disabled applicant workers that have applied to work in positions by the winning second bidder 14. The non-profit 22 could send the resumes of any or all of the disabled applicant workers to the prime contractor (i.e., the contact person) for hiring consideration.

Although not shown on the flowchart, it is considered likely that ultimately some of the disabled workers will be hired by the prime contractor and that the non-profit will be informed as to which of the referral candidates it has sent are to work at the location of the prime contractor. These disabled workers remain technically as employees of the non-profit 22. They typically work at the site of the prime contractor, although in select instances telecomuting or other remotely located job opportunities may be possible.

The prime contractor then timely pays the non-profit 22 the salary plus some percentage for overhead for each disabled worker that it hires for as long as that person continues to work on the respective contract. The non-profit 22 then timely pays the wages of each disabled worker. The interval at which payment occurs is, of course, a variable.

As described earlier, because the method and system for job-placement of disabled workers 10 fosters job opportunities for disabled and blind individuals, it is anticipated that government contracts will routinely include a requirement that at least a certain minimum percentage of the workers that the prime contractor (i.e., the second bidder 14 in this example) uses must come from the disabled or blind worker pool, each of the bidders 12, 14, 16 factors this expense into their bid proposal.

Indeed, the method and system for job-placement of disabled workers 10 is anticipated to affect (i.e., amend) either the wording or implementation of JWOD by requiring most or all bidders 12, 14, 16 to solicit disabled and blind workers of varying abilities (i.e., skills) from across the spectrum of skill levels for most if not all government procurement contracts, rather than continuing to focus on low-skilled job opportunities for disabled workers.

Again, it is stated that all of the disabled workers remain always as employees of the non-profit 22 (to satisfy JWOD requirements). They work at the location of the prime contractor (the second bidder 14), a private sector company, and do so on a long-term basis (i.e., they are hired for contracts over one year in duration).

The fundamental service that is provided by the non-profit 22 is that of a national staffing service for disabled and blind individuals of varying talents and abilities who wish to work with or at the location of a private sector company on a long-term government procurement contract that the company has been awarded. For any given geographical area, the non-profit 22 is able to timely solicit talent from the pool of disabled and blind individuals in that area and provide the private sector company (i.e., the prime contractor) with a pool of disabled and blind applicants from which the company can choose to hire those individuals that the company feels are best suited or able to satisfy the required positions.

The number of disabled workers and their skills will, of course, vary from location to location. There may be more disabled engineers available in one geographical area than in some other, but a key benefit that is provided by the method and system 10 is that for any given geographical area, an optimal pool of disabled talent is made available to the prime contractor to choose from and this offering is accomplished promptly once the contract has been awarded. This early type of a staffing or human-resources referral service also helps the disabled individuals quickly get a foot in the door, so to speak, having been pre-screened even before the contract was awarded. Therefore, not only are additional job opportunities made available to the disabled population but disabled individuals become among the first employees to start working on any given government contract that has been awarded to a private sector company.

The prime contractor pays the non-profit 22 the salary of each disabled worker which the non-profit 22 has referred thereto and which the prime contractor has elected to hire plus overhead and administrative costs of the non-profit 22. (This was described briefly hereinabove and is further described in greater detail hereinafter.)

Each of the bidders 12, 14, 16 is also aware of any mandate in place requiring them to hire a certain percentage of disabled workers for any government contract and of the need to do so for as wide a variety of skill levels as disabled workers are available in any given area to satisfy.

The bidders 12, 14, 16 therefore include in their bid proposals all of the added costs that are expected to arise from the hiring of the disabled workers including their salary, a percentage above their base salary used by the non-profit for the payment of taxes, unemployment insurance, etc. for each of the disabled workers, a small percentage for administration fees of the non-profit 22 that is used to pay for the functioning of the non-profit 22, and for any special facility requirements or support services that may be needed at the location of the prime contractor by the disabled workers.

This cost then, is ultimately passed on to the federal government in the form of slightly higher bid proposal estimates. The government does not shy from this increase but, as described hereinabove, welcomes it because it has already been well established that the small increase in the cost of each contract is far offset by the savings that arise from the employment of additional disabled workers.

While the application of the method and system for job-placement of disabled workers 10 has been described with particularity for use in federal government procurement contracts, the method and system 10 is also applicable for modification, as desired, and for use with state and even local government procurement contracts.

While the method and system for job-placement of disabled workers 10 has been described in great detail hereinabove for use prior to and then after the actual awarding of the government contract, it is also suitable for use in those cases when a government contract has been awarded and no advance notification or posting of jobs has occurred.

In such instances, the private sector company that has already been awarded the contract (not shown) which can be either a prime contractor or a sub-contractor to the prime contacts the non-profit 22 to obtain their services, the contact occurring either directly or indirectly going first through NIB or NISH 18. The non-profit 22 then solicits and hires appropriate disabled or blind individuals to fill certain of the available job positions. As described hereinabove, the prime or sub-contractor may interview and select the disabled individuals that it wishes to hire from amongst those that are referred by the non-profit 22.

The flowchart of FIG. 2 would then be modified so as to include only the winning second bidder 14 (because the contract was already awarded to the second bidder 14 before use of the system 10 first began) supplying information to NIB or NISH (or alternatively directly to the non-profit 22). The steps of soliciting disabled applicants, creating a potential worker file and informing and referring candidates (all or some) would remain the same. The step of waiting to determine the winning bidder would not be necessary.

The winning second bidder 14 can also be a subcontractor. If the government contract requires one-thousand jobs, seven-hundred of which are to be filled by the prime contractor and three-hundred of which are to be filled by the subcontractor, the subcontractor can also make avail of the system 10 in any of the described embodiments.

The invention has been shown, described, and illustrated in substantial detail with reference to the presently preferred embodiment. It will be understood by those skilled in this art that other and further changes and modifications may be made without departing from the spirit and scope of the invention which is defined by the claims appended hereto.

What is claimed is:

1. A system for job-placement of disabled workers, comprising:
(a) means adapted for storing files for a not for profit staffing service, wherein said files include information appertaining to at least one job opportunity that is necessary to satisfy a government contract and wherein said at least one job opportunity includes working with a private-sector company that has applied to be a contractor to fulfill said government contract and wherein said job opportunity includes an estimated term that is at least one year in duration;
(b) means for informing a plurality of disabled or blind individuals of said at least one job opportunity; and
(c) means for creating a potential worker file of applicants, said applicants including those of said plurality of disabled or blind individuals who apply for said at least one job opportunity;
whereby said non-profit staffing service is adapted to hire at least one of said applicants and to assign said at least one of said applicants to work at a location that is designated by said private-sector company that is selected as a contractor to fulfill said government contract.

2. The system for job-placement of disabled workers of claim 1 wherein said staffing service includes a non-profit organization.

3. The system for job-placement of disabled workers of claim 1 wherein said job opportunity includes a potential job opportunity.

4. The system for job-placement of disabled workers of claim 1 wherein said job opportunity includes a current job opportunity.

5. The system for job-placement of disabled workers of claim 1 wherein said government contract includes a pending government contract.

6. The system for job-placement of disabled workers of claim 1 wherein said government contract includes an awarded government contract.

7. The system for job-placement of disabled workers of claim 1 wherein said contractor includes a prime contractor.

8. The system for job-placement of disabled workers of claim 1 wherein said contractor includes a subcontractor.

9. The system for job-placement of disabled workers of claim 1 including means adapted for cooperating with said private-sector company to select certain of said applicants from amongst said applicants wherein an opportunity for employment will be offered to each of said certain of said applicants.

10. The system for job-placement of disabled workers of claim 1 wherein said potential job opportunity includes a plurality of potential job opportunities.

11. The system for job-placement of disabled workers of claim 1 wherein said means for creating a potential worker file of applicants includes creating a potential worker file of applicants that have applied to fulfill the needs of said private sector company that appertains to said government contract.

12. The system for job-placement of disabled workers of claim 1 wherein said private-sector company that has applied to be a prime contractor to fulfill said pending government contract includes a plurality of private-sector companies that have each applied to fulfill said pending government contract.

13. The system for job-placement of disabled workers of claim 12 wherein said means for creating a potential worker file of applicants includes creating a plurality of potential worker files of applicants and wherein each of said plurality of potential worker files of applicants includes those applicants that have applied to fulfill the needs of one of said plurality of private sector companies.

14. The system for job-placement of disabled workers of claim 1 wherein said means for creating a potential worker file of applicants includes storing said potential worker file in a database.

15. The system for job-placement of disabled workers of claim 1 wherein said means for informing a plurality of disabled or blind individuals of said at least one potential job opportunity includes a posting thereof on a web site of the Internet.

16. The system for job-placement of disabled workers of claim 1 wherein said information includes means for obtaining said information about said government contract and wherein said means for obtaining is mediated by a central not for profit organization.

17. The system for job-placement of disabled workers of claim 16 wherein said central not for profit organization is designated by a committee for purchase of services from blind and severely disabled to distribute that work.

18. The system for job-placement of disabled workers of claim 17 wherein said committee for purchase of services includes a federal agency that is designated to oversee the implementation of JWOD legislation.

19. The system for job-placement of disabled workers of claim 1 wherein said information includes means for obtaining said information about said government contract and wherein said means for obtaining said information about said government contract is mediated by the National Industries for the Blind organization

20. The system for job-placement of disabled workers of claim 1 wherein said information includes means for obtaining said information about said government contract and wherein said means for obtaining said information about said government contract is mediated by the National Industries for the Severely Handicapped organization.

21. The system for job-placement of disabled workers of claim 1 wherein said information includes means for obtaining information about said government contract and wherein said means for obtaining is mediated by at least one agent, said at least one agent designated by a state legislated disability program.

22. The system for job-placement of disabled workers of claim 1 wherein said information includes means for obtaining said information and wherein said means for obtaining said information includes said each of said private-sector companies contacting said non-profit staffing service.

23. The system for job-placement of disabled workers of claim 1 wherein said information includes means for obtaining said information and wherein said means for obtaining said information includes said non-profit staffing service contacting said private-sector company subsequent to said private-sector company being awarded at least a portion of said government contract.

24. The system for job-placement of disabled workers of claim 1 including means for sending at least some of said plurality of disabled or blind individuals an email using the Internet.

25. The system for job-placement of disabled workers of claim 1 wherein said not for profit organization employs disabled or blind individuals that comprise at least seventy-five percent of its work force that is performing direct labor.

26. The system for job-placement of disabled workers of claim 1 wherein said means for informing said applicants subsequent to said private sector company being awarded said government contract includes means for referring said applicants to said private sector company.

27. The system for job-placement of disabled workers of claim 1 wherein said means for informing said applicants subsequent to said private sector company being awarded said government contract includes providing said private sector company with information appertaining to at least one of said applicants, wherein said information is sufficient to permit said private sector company to make an attempt to contact said at least one of said applicants.

28. The system for job-placement of disabled workers of claim 1 wherein said at least one of said applicants that is hired by said private sector company remains as an employee of said not for profit staffing service for the duration of said estimated term.

29. The system for job-placement of disabled workers of claim 1 wherein said means adapted for storing files includes a server and a data base that are adapted to cooperate with each other and wherein said server is adapted to communicate over the Internet and wherein said data base is adapted for storing said files.

30. A method for job-placement of disabled workers, comprising:
(a) providing a not for profit staffing service that is adapted to receive information appertaining to at least one job opportunity that is necessary to satisfy a government contract and wherein said at least one job opportunity includes working with a private-sector company that has applied to be a contractor to fulfill said pending government contract and wherein said job opportunity includes an estimated term that is at least one year in duration;
(b) informing a plurality of disabled or blind individuals of said at least one job opportunity; and
(c) creating a potential worker file of applicants, said applicants including those of said plurality of disabled or blind individuals who apply for said at least one potential job opportunity;
whereby said not for profit staffing service is adapted to hire at least one of said applicants and to assign said at least one of said applicants to work at a location that is designated by said private-sector company that is selected as a contractor to fulfill said government contract.

31. The method for job-placement of disabled workers of claim 30 wherein the step of providing a not for profit staffing service includes providing a non-profit organization as said not for profit staffing service.

32. The method for job-placement of disabled workers of claim 30 wherein the step of providing a not for profit staffing service includes providing a potential job opportunity as said job opportunity.

33. The method for job-placement of disabled workers of claim 30 wherein the step of providing a not for profit staffing service includes providing a current job opportunity as said job opportunity.

34. The method for job-placement of disabled workers of claim 30 wherein the step of providing a not for profit staffing service includes providing a pending government contract as said government contract.

35. The method for job-placement of disabled workers of claim 30 wherein the step of providing a not for profit staffing service includes providing an awarded government contract as said government contract.

36. The method for job-placement of disabled workers of claim 30 wherein the step of providing a not for profit staffing service includes providing a prime contractor as said contractor.

37. The method for job-placement of disabled workers of claim 30 wherein the step of providing a not for profit staffing service includes providing a subcontractor as said contractor.
